(19) United States
(12) Patent Application Publication
(10) Pub. No.: US 2002/0091580 A1
(43) Pub. Date: Jul. 11, 2002

(54) Method for integrating e-commerce business model and transaction platform therefor

(76) Inventor: Su Hsin Wang, Shen Ken City (TW)

Correspondence Address: BACON & THOMAS, PLLC, 4th Floor, 625 Slaters Lane, Alexandria, VA, 22314-1176, US

(21) Appl. No.: 09/757,598

(22) Filed: Jan. 11, 2001

(51) Int. Cl. G06F 17/60

(52) U.S. Cl. 705/26; 705/37

(57) ABSTRACT

A method for integrating e-commerce business model and transaction platform therefor is disclosed for integrating B2B, B2C, C2B, and C2C on the same transaction platform, effecting one to multiple transaction, and effecting multiple to multiple transaction. By utilizing this, a variety of advantages are obtained. For example, buyers and sellers may choose an advantageous business model based on the real market conditions with respect to the demand and the supply situations. Further, a fully competitive marketing economy is effected. Furthermore, a simplified business model and supply chains relationship are obtained. Moreover, a fair, open, high efficiency, and low cost transaction is carried out.

### BACKGROUND OF THE INVENTION

1. Field of the Invention

The present invention relates to e-commerce and more particularly to a method for integrating e-commerce business model and transaction platform therefor.

2. Description of Related Art

A typical e-commerce business model is generally divided into business to business (B2B), business to consumer (B2C), consumer to business (C2B), and consumer to consumer (C2C). In a typical e-commerce transaction platform, a transaction is initiated by seller through a single transaction platform. In brief, it simply executes a typical commercial transaction (e.g., selling or bidding) through the Internet. The characteristics of above is that it is an individual transaction and the service party is specific. Further, a buyer involved a group of people is rare. The business model is controlled by seller due to the limitation on the number of partners and the information accessibility. As such, price variation is limited. It is impossible to reflect real market with respect to demand and supply. Further, seller and buyer can not adopt different buying/selling strategies based on real market condition because this is a single transaction platform configuration. This lacks flexibility and fairness in transaction. With the current e-commerce business model, mechanism, and method, a number of goals such as integrating B2B, B2C, C2B, and C2C on the same transaction platform, effecting one to multiple transaction, and effecting multiple to multiple transaction, are not achievable because there is no document available for solving such problems.

### SUMMARY OF THE INVENTION

It is an object of the present invention to achieve the goals of integrating B2B, B2C, C2B, and C2C on the same transaction platform, effecting one to multiple transaction, and effecting multiple to multiple transaction. By utilizing this, a variety of advantages are obtained. For example, buyers and sellers may choose an advantageous business model based on the real market conditions with respect to the demand and the supply situations. Further, a fully competitive marketing economy is effected. Furthermore, a simplified business model and supply chains relationship are obtained. Moreover, a fair, open, high efficiency, and low cost transaction is carried out.

In one aspect of the present invention, a method for integrating e-commerce business models comprising the steps of:

(a) classifying a demand initiation published on homepage as both buyer's buying information and seller's selling information;

(b) integrating a transaction information including classifying the publishing information on the demand initiation as two categories wherein one is buyer marketplace/seller marketplace and the other is new product/used product/services based on the combination of the buyer's buying information and the seller's selling information, and then integrating the same into a database;

(c) establishing a transaction marketplace including establishing a buyer marketplace and a seller marketplace based on the database;

(d) classifying a transaction item as new product, used product, and services based on the database;

(e) establishing a transaction mechanism including creating an invitation to bid for a group buying/auction bidding, an invitation to bid for a single party/auction bidding, an invitation to bid/group buying auction bidding, and a request for publication services from buyer/seller transaction models based on the transactional marketplace establishment and the transaction item classification;

(f) creating a transaction rule including creating transaction rules of closing bid, opening bid, and announcing bid based on the transaction mechanism created in step (e);

(g) defining a number of transaction party as 1 to N or N to N based on the transaction mechanism created in step (e) and transaction rule created in step (f); and

(h) setting a transaction price based on the transaction rule created in step (f) to announce a reasonable and mutual beneficial price and then come to a transaction price.

The above and other objects, features and advantages of the present invention will become apparent from the following detailed description taken with the accompanying drawings.

### BRIEF DESCRIPTION OF THE DRAWINGS

FIG. 1 is a flow chart of method for integrating e-commerce business model in accordance with the invention;

FIGS. 2A and 2B schematically show the integrating analysis table of the invention;

FIG. 3A is a block diagram illustrating a business model involved C2B, buyer market, and new product in N to N transaction party of the invention;

FIG. 3B is a block diagram illustrating a business model involved B2C, seller market, and new product in 1 to N transaction party of the invention;

FIG. 4A is a block diagram illustrating a business model involved B2B, buyer market, and new product in N to N transaction party of the invention;

FIG. 4B is a block diagram illustrating a business model involved B2B, seller market, and new product in 1 to N transaction party of the invention;

FIG. 5A is a block diagram illustrating a business model involved C2C, buyer market, and used product in 1 to N transaction party of the invention;

FIG. 5B is a block diagram illustrating a business model involved C2C, seller market, and used product in 1 to N transaction party of the invention;

FIG. 6A is a flow chart illustrating a business model involved C2B, buyer market, and new product in N to N transaction party of the invention;

FIG. 6B is a flow chart illustrating a business model involved B2C, seller market, and new product in 1 to N transaction party of the invention;

FIG. 7A is a flow chart illustrating a business model involved B2B, buyer market, and new product in N to N transaction party of the invention;

FIG. 7B is a flow chart illustrating a business model involved B2B, seller market, and new product in 1 to N transaction party of the invention;

FIG. 8A is a flow chart illustrating a business model involved C2C, buyer market, and used product in I to N transaction party of the invention;

FIG. 8B is a flow chart illustrating a business model involved C2C, seller market, and used product in 1 to N transaction party of the invention;

FIGS. 9A and 9B are views showing preferred embodiment homepages of invitation to bid for seller selling of the invention, respectively;

FIGS. 10A and 10B are views showing preferred embodiment homepages of invitation to bid for buyer group buying of the invention, respectively;

FIGS. 11A and 11B are views showing preferred embodiment homepage of seller submitting bid for offering price of the invention, respectively; and

FIGS. 12A and 12B are views showing preferred embodiment homepage of bid announcing state of the invention, respectively.

### DETAILED DESCRIPTION OF THE PREFERRED EMBODIMENTS

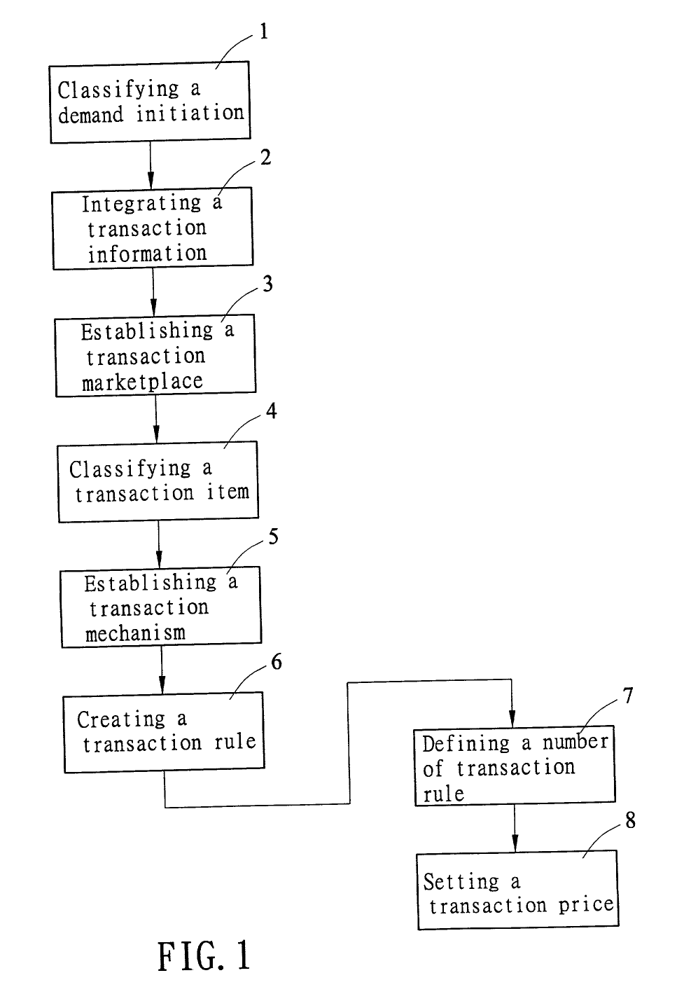

Referring to FIG. 1, there is shown a method for integrating e-commerce business model in accordance with the invention. The method comprises the steps of:

(1) classifying a demand initiation published on homepage as both buyer's buying information and seller's selling information;

(2) integrating a transaction information including classifying the publishing information on the demand initiation as two categories wherein one is buyer marketplace/seller marketplace and the other is new product/used product/services based on the combination of the buyer's buying information and the seller's selling information, and then integrating the same into a database;

(3) establishing a transaction marketplace including establishing a buyer marketplace and a seller marketplace based on the database;

(4) classifying a transaction item as new product, used product, and services based on the database;

(5) establishing a transaction mechanism including creating an invitation to bid for a group buying/auction bidding, an invitation to bid for a single party/auction bidding, an invitation to bid/group buying auction bidding, and a request for publication services from buyer/seller transaction models based on the transactional marketplace establishment and the transaction item classification;

(6) creating a transaction rule including creating transaction rules of closing bid, opening bid, and announcing bid based on the transaction mechanism created in step (5);

(7) defining a number of transaction party as 1 to N or N to N based on the transaction mechanism created in step (5) and transaction rule created in step (6); and

(8) setting a transaction price based on the transaction rule created in step (6) to announce a reasonable and mutual beneficial price and then come to a transaction price.

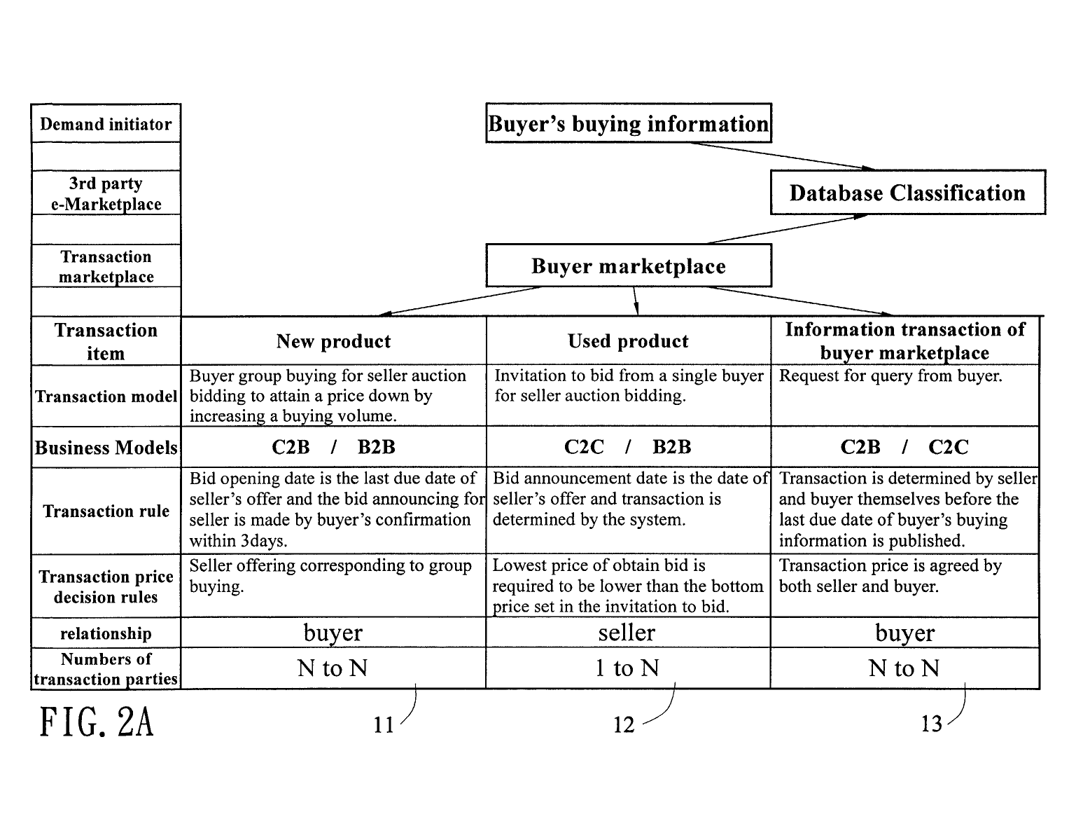

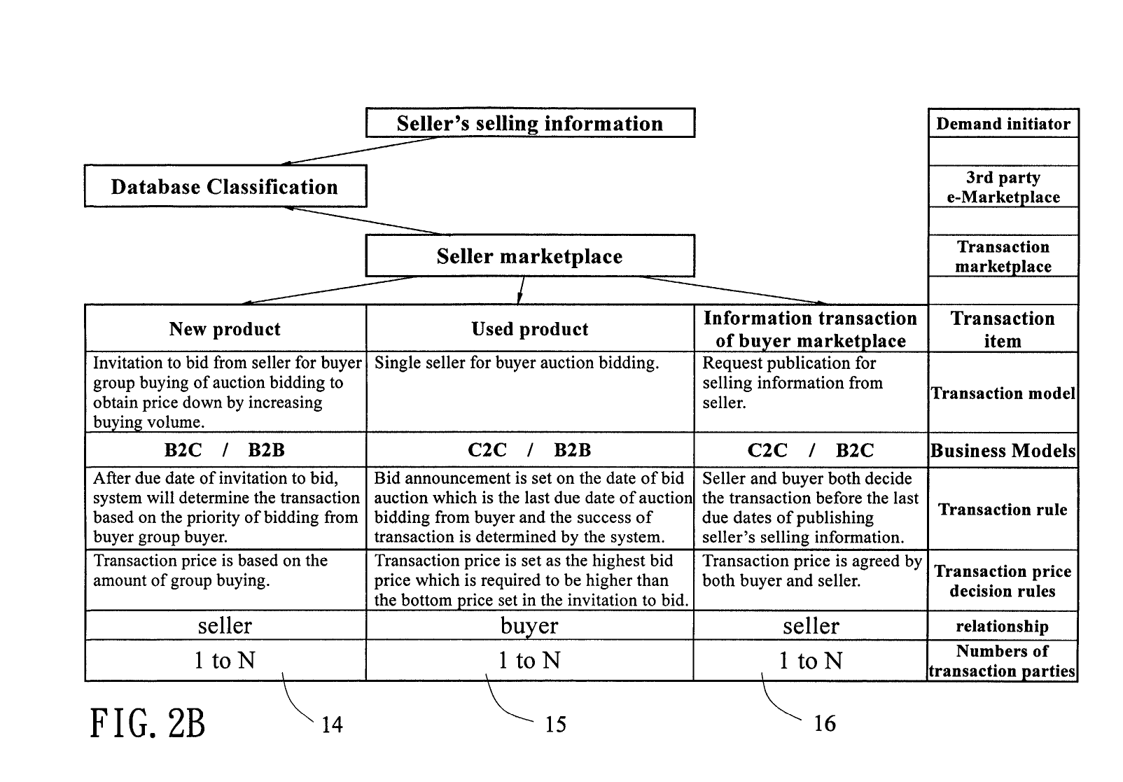

Referring to FIGS. 2A and 2B, it schematically shows the integrating analysis table of the invention wherein a transaction platform comprises: new product transaction of buyer marketplace 11 wherein after having published the buying information on a homepage by the buyer, the transaction model is an invitation to bid from buyer group buying for seller auction bidding to attain a price down by increasing a buying volume; the business models are C2B and B2B; the transaction rule is that the bid opening date is set on the date of registration which is the last due date of offering from seller and the bid announcing for seller is made by buyer's confirmation within three days counting from the bid opening date; the number of transaction party is N to N; the transaction price is set as seller offering price corresponding to an amount of group buying, and the master is buyer;

used product transaction of buyer marketplace 12 wherein after having published buying information, the transaction model is an invitation to bid from a single buyer for seller auction bidding; the business models are C2C and B2B; the transaction rule is that the bid announcement date is set on the date of registration which is the last due date of offering from seller and the success of transaction is determined by the system; the number of transaction party is 1 to N; the transaction price is set as the lowest bid price which is required to be lower than the bottom price set in the invitation to bid, and the master is buyer;

information transaction of buyer marketplace 13 wherein after having published buyer's buying information, the transaction model is a request for query (RFQ) from buyer; the business models are C2B and C2C; the transaction rule is that making transaction is determined by the seller and buyer themselves before the last due date of buyer's buying information is published; the number of transaction party is N to N, transaction price is agreed by both buyer and seller, and the master is buyer;

new product transaction of seller marketplace 14 wherein after having published seller's selling information; the transaction model is an invitation to bid from seller for buyer group buying of auction bidding to obtain price down by increasing buying volume, the business models are B2C and B2B, the transaction rule is that the system will determine the transaction based on the priority of bidding from buyer groups buying after the due date of bid invitation; the number of transaction party is 1 to N; the transaction price is based on the amount of group buying, and the master is seller;

used product transaction of seller marketplace 15 wherein after having published seller's selling information, the transaction model is an invitation to bid from a single seller for buyer auction bidding, the business models are C2C and B2B, the transaction rule is that the bid announcement is set on the date of bid auction which is the last due date of auction bidding from buyer and the success of transaction is determined by the system, the number of transaction party is 1 to N, the transaction price is set as the highest bid price which is required to be higher than the bottom price set in the invitation to bid, and the master is seller; and

information transaction of seller marketplace 16 wherein after having published the seller's selling information, the transaction model is request publication for selling information from seller, the business models are C2C and B2C, the transaction rule is that seller and buyer both decide the transaction before the last due dates of publishing seller's selling information, the number of transaction party is 1 to N, transaction price is agreed by both buyer and seller, and the master is seller.

To make further description in detail of actual operational mechanism and operational rule in accordance with the present invention, a number of preferred embodiments in accompanying with a related illustrative block diagram and flow chart are described as follows:

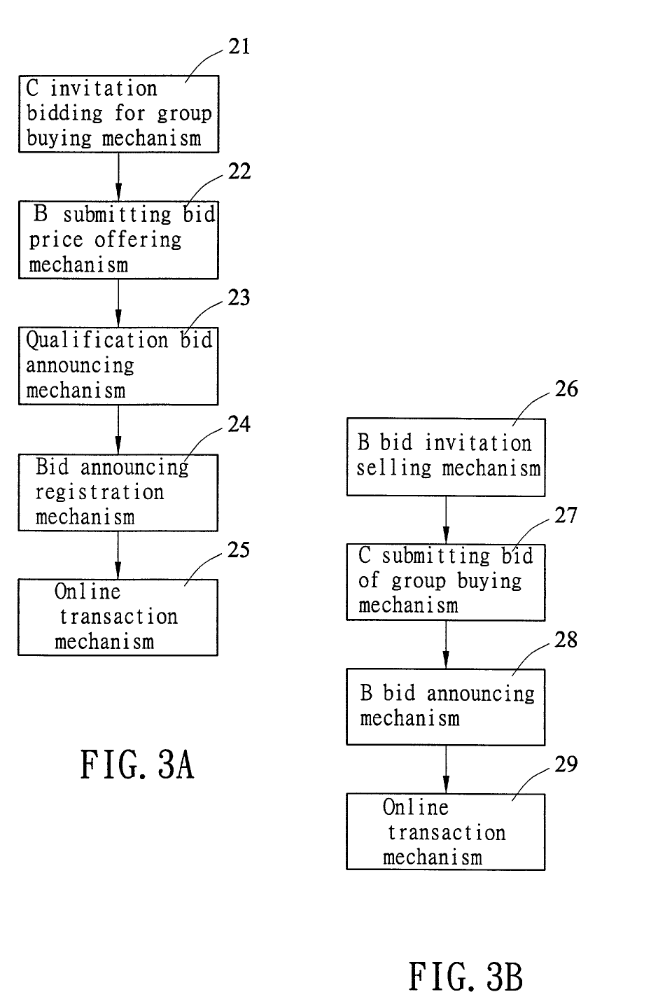

Referring to FIG. 3A, a block diagram is illustrating a transaction model involved N to N transaction party, buyer marketplace, and new product in C2B business model of the invention. As shown, transaction model comprises a C invitation bid for group buying mechanism 21, a B submitting bid price offering mechanism 22, a qualification bid announcing mechanism 23, a C bid announcing registration mechanism 24, and an online transaction mechanism 25 wherein the C is buyer, the B is seller, and the number of transaction party is N to N.

FIG. 3B is a block diagram illustrating a transaction mode involved 1 to N transaction party, seller marketplace, and new production B2C business model of the invention. As shown, transaction model comprises a B invitation to bid selling mechanism 26, a C submitting bid of group buying mechanism 27, a B bid announcing mechanism 28, and an online transaction mechanism 29 wherein the C is buyer, the B is seller, and the number of transaction party is 1 to N.

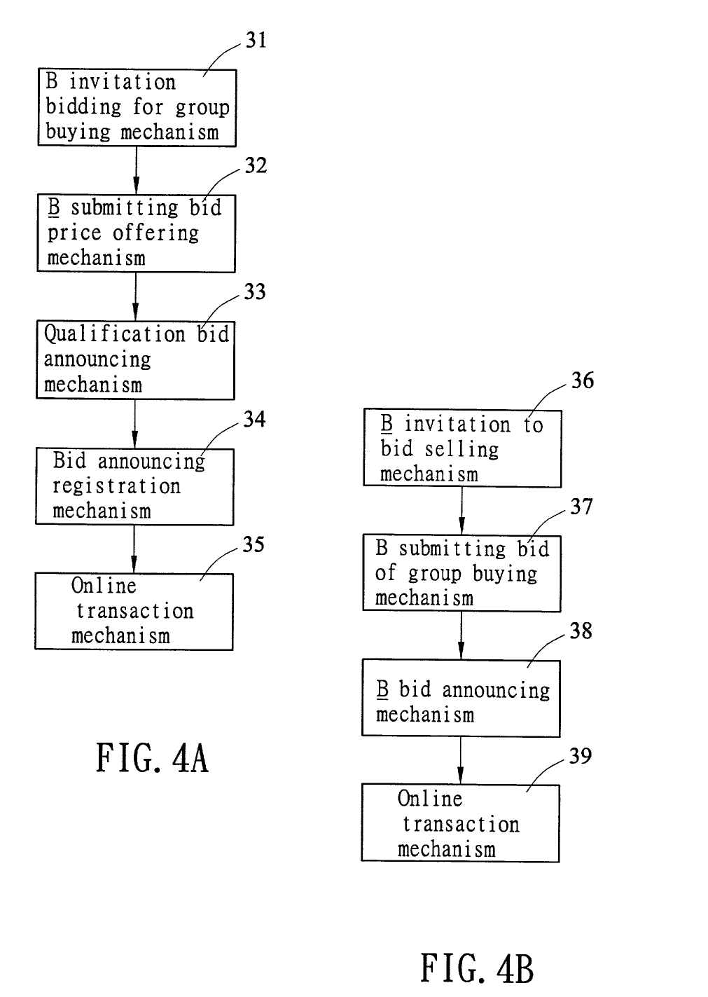

FIG. 4A is a block diagram illustrating a transaction model involved N to N transaction party, buyer marketplace, and new product in B2B business model of the invention. As shown, transaction model comprises a B invitation biding for group buying mechanism 31, a B′ submitting bid price offering mechanism 32, a qualification bid announcing mechanism 33, a B bid announcing registration mechanism 34, and an online transaction mechanism 35 wherein the B is buyer (e.g., downstream manufacturers of a large company), the B′ is seller (e.g., upstream providers of a large company), and the number of transaction party is N to N.

FIG. 4B is a block diagram illustrating a transaction model involved 1 to N transaction party, seller marketplace, and new product in B2B business model of the invention. As shown, transaction model comprises a B′ invitation to bid selling mechanism 36, a B submitting bid group buying mechanism 37, a B′ bid announcing mechanism 38, and an online transaction mechanism 39 wherein the B is buyer (e.g., downstream manufacturers of a large company), the B′ is seller (e.g., upstream providers of a large company), and the numbers of transaction party is 1 to N.

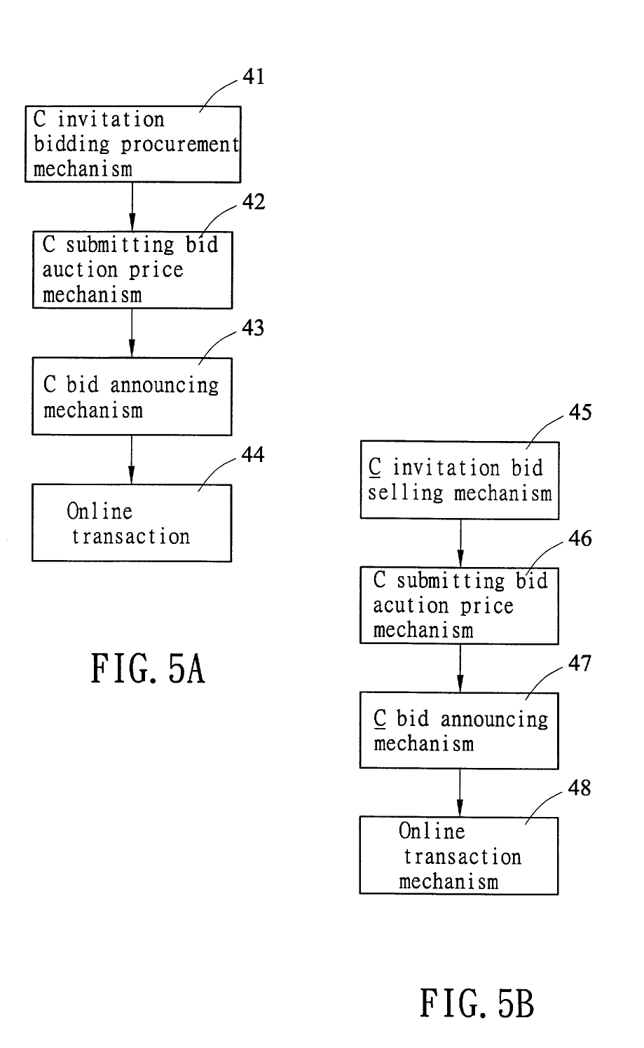

FIG. 5A is a block diagram illustrating a transaction model involved 1 to N transaction party, buyer marketplace, and used product in C2C business model of the invention. As shown, transaction model comprises a C invitation biding mechanism for procurement 41, a C′ submitting bid auction price mechanism 42, a C bid announcing mechanism 43, and an online transaction mechanism 44 wherein the C is buyer, the C′ is seller, and the number of transaction party is 1 to N. Note that the transaction model is also applicable to used product transaction between B2B.

FIG. 5B is a block diagram illustrating a transaction model involved 1 to N transaction party, seller market, and used product in C2C business model of the invention. As shown, transaction model comprises a C invitation bid mechanism for selling 45, a C submitting bid auction price mechanism 46, a C bid announcing mechanism 47, and an online transaction mechanism 48 wherein the C is buyer, the C′ is seller, and the number of transaction party is 1 to N. Note that the business model is also applicable to used product transaction between B2B.

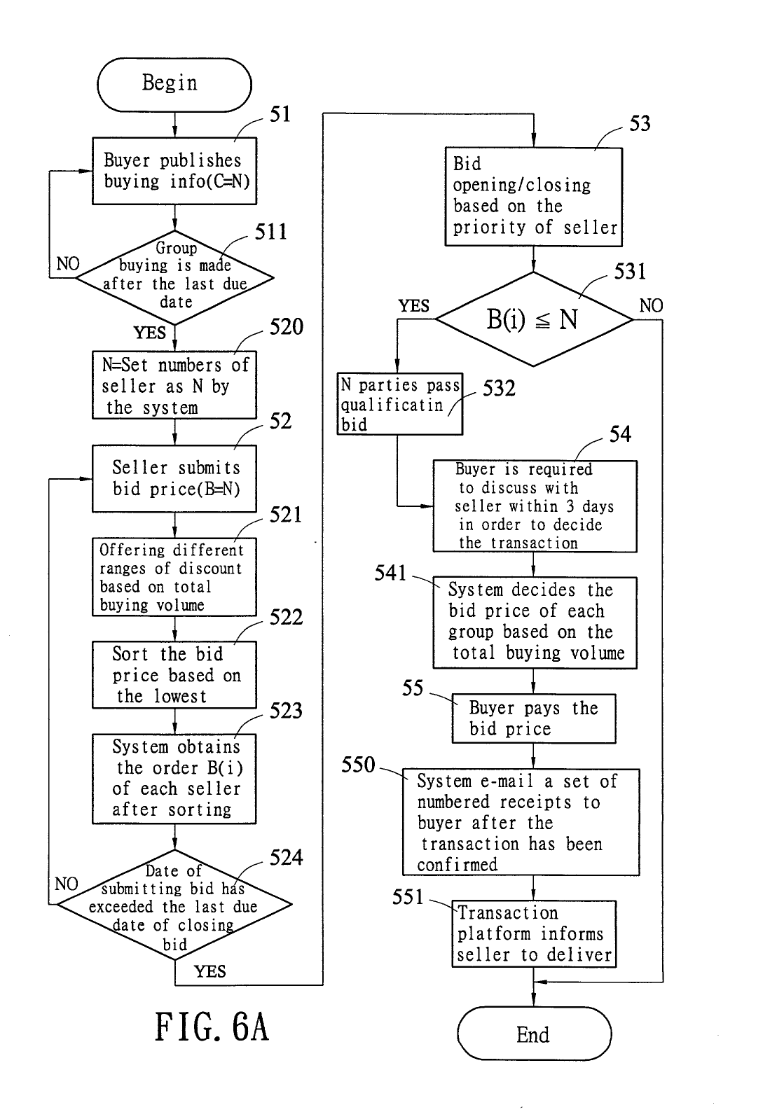

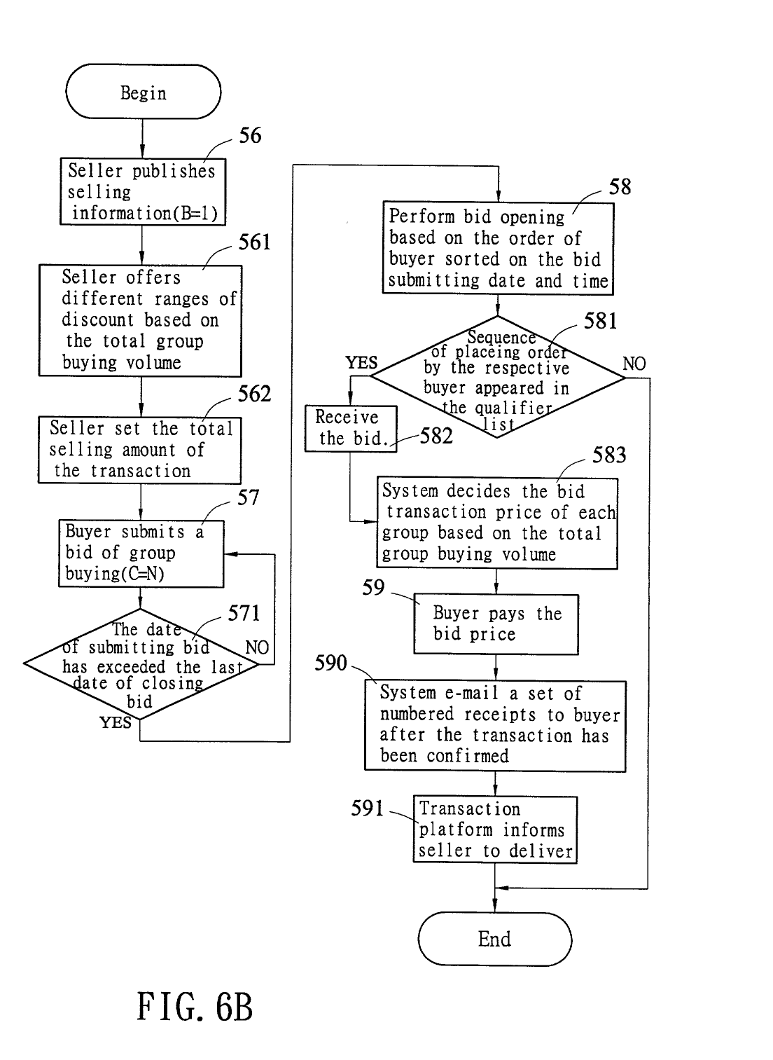

FIG. 6A is a flow chart illustrating a transaction model involved N to N transaction party, buyer marketplace, and new product in C2B business model of the invention. The process comprises the steps of:

In step 51, buyer publishes buying information and C is equal to N (C=N). In step 511, a determination is made whether the group buying is made after the last day specified. If no, the process loops back to step 51. If yes, process goes to step 520.

In step 520, set the number of seller as N by the system.

In step 52, submit bid price of seller and B=N.

In step 521, seller offers a different ranges of discount based on total buying volume.

In step 522, sort the bid price based on the lowest.

In step 523, system obtains the order B(i) of each seller after sorting.

In step 524, it is determined that whether the date of presenting bid has exceeded the last date of closing bid . If no, process loops back to step 52. If yes, process goes to step 53.

In step 53, perform bid opening based on the priority specified in B(i) of seller.

In step 531, it is determined that whether B(i) is equal to or less than N. If yes, process goes to step 532. Otherwise, the process ends.

In step 532, set B(i) as qualifier until there are N such B(i)s.

In step 54, buyer is required to discuss with seller within three days in order to decide the transaction.

In step 541, the system decides the bid price of each group based on the total buying volume.

In step 55, buyer pays the bid price.

In step 550, the system e-mail a set of numbered receipts to buyer after the transaction has been confirmed.

In step 551, the transaction platform of the invention informs seller to deliver.

FIG. 6B is a flow chart illustrating a business model involved 1 to N, seller marketplace, and new product in B2C of the invention. The process comprises the steps of:

In step 56, seller publishes selling information and B is equal to 1 (B=1). In step 561, seller offers different ranges of discount based on total group buying volume.

In step 562, seller sets the total selling amount of the transaction for providing a number of corresponding transactions.

In step 57, submit bid group buying for buyer and C=N.

In step 571, it is determined that whether the date of presenting bid has exceeded the last date of closing bid , before the due date of closing bid, any other buyer may still submitting a bid to participate group buying. If no, process loops back to step 57. If yes, process goes to step 58.

In step 58, perform bid opening based on the order of buyer sorted on the bid submitting date and time.

In step 581, it is determined that whether the sequence of placing order by the respective buyer is appeared in the qualifier list. If yes, process goes to step 582. If not, process ends.

In step 582, the buyer is decided to receive the bid.

In step 583, system decides the transacting price of each group based on the total group buying volume.

In step 59, buyer pays the bid price.

In step 590, the system e-mail a set of numbered receipts to buyer after the transaction has been confirmed by the system.

In step 591, the transaction platform of the invention informs seller to deliver.

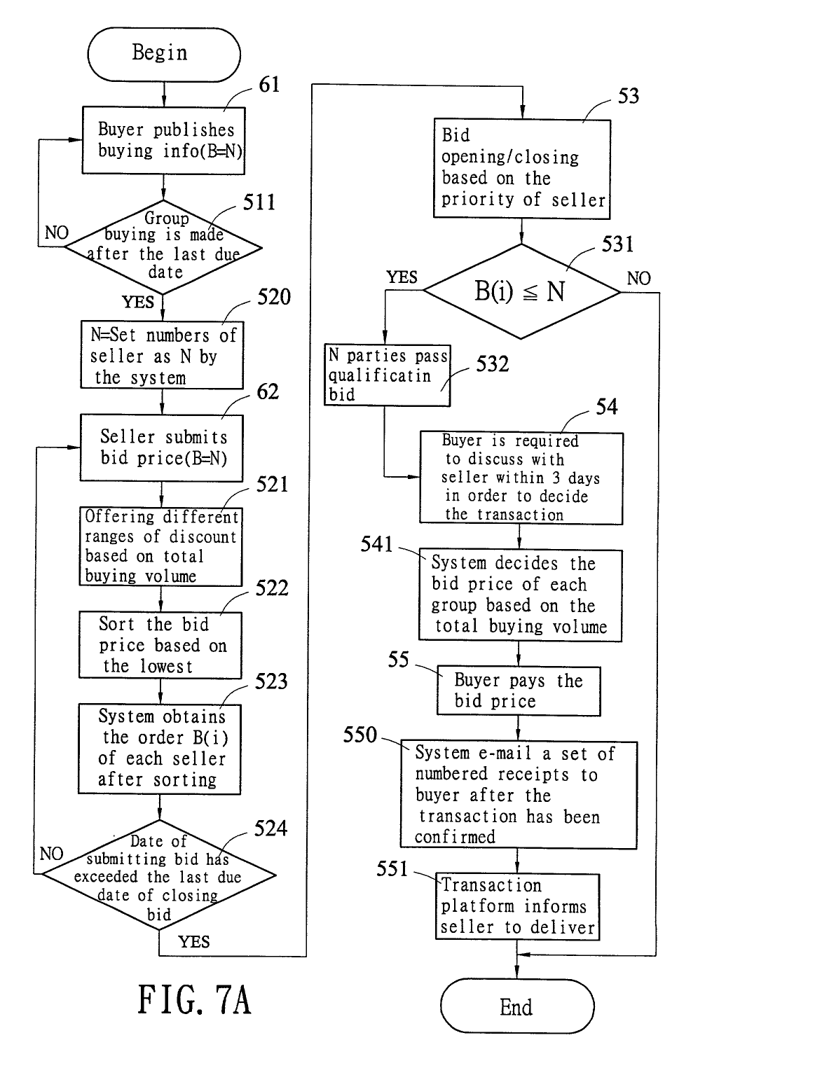

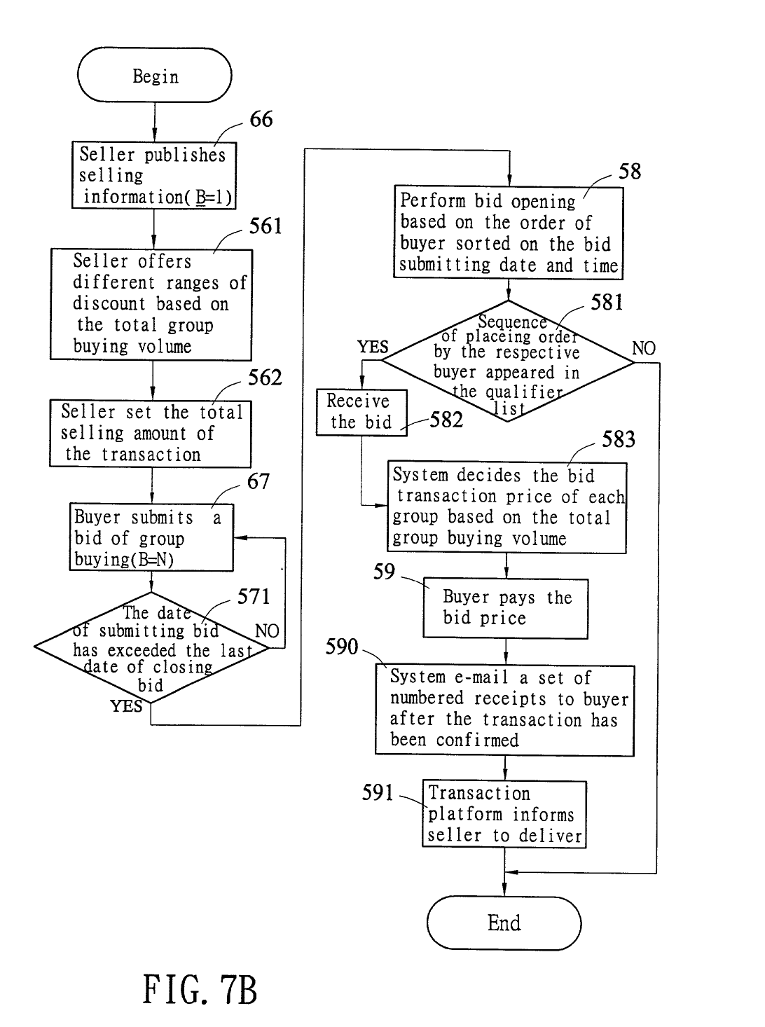

FIG. 7A is a flow chart illustrating a business model involved N to N, buyer marketplace, and new product in B2B of the invention. The process comprises the steps of:

In step 61, it is the same as step 51 with respect to information published by buyer. The only difference is that transaction party is B and B is equal to N (B=N) wherein B is buyer (e.g., downstream manufacturers of a large company).

In step 62, it is the same as step 52 with respect to bid price set by seller. The only difference is that transaction party is B′ and B′ is equal to N (B′=N) wherein B′ is seller (e.g., upstream providers of a large company).

The description of other remaining steps is omitted herein because they are the same as those described in FIG. 6A.

FIG. 7B is a flow chart illustrating a transaction model involved 1 to N transaction party, seller marketplace, and new product in B2B business model of the invention.

In step 66, it is the same as step 56 with respect to information published by seller. The only difference is that transaction party is B′ and B′ is equal to N (B=1) wherein B′ is seller (e.g., upstream providers of a large company).

In step 67, it is the same as step 57 with respect to the submitting bid of group buying for buyer. The only difference is that transaction party is B and B is equal to N (B=N) wherein B is buyer (e.g., downstream manufacturers of a large company).

The description of other remaining steps is omitted herein as they are the same as those described in FIG. 6B.

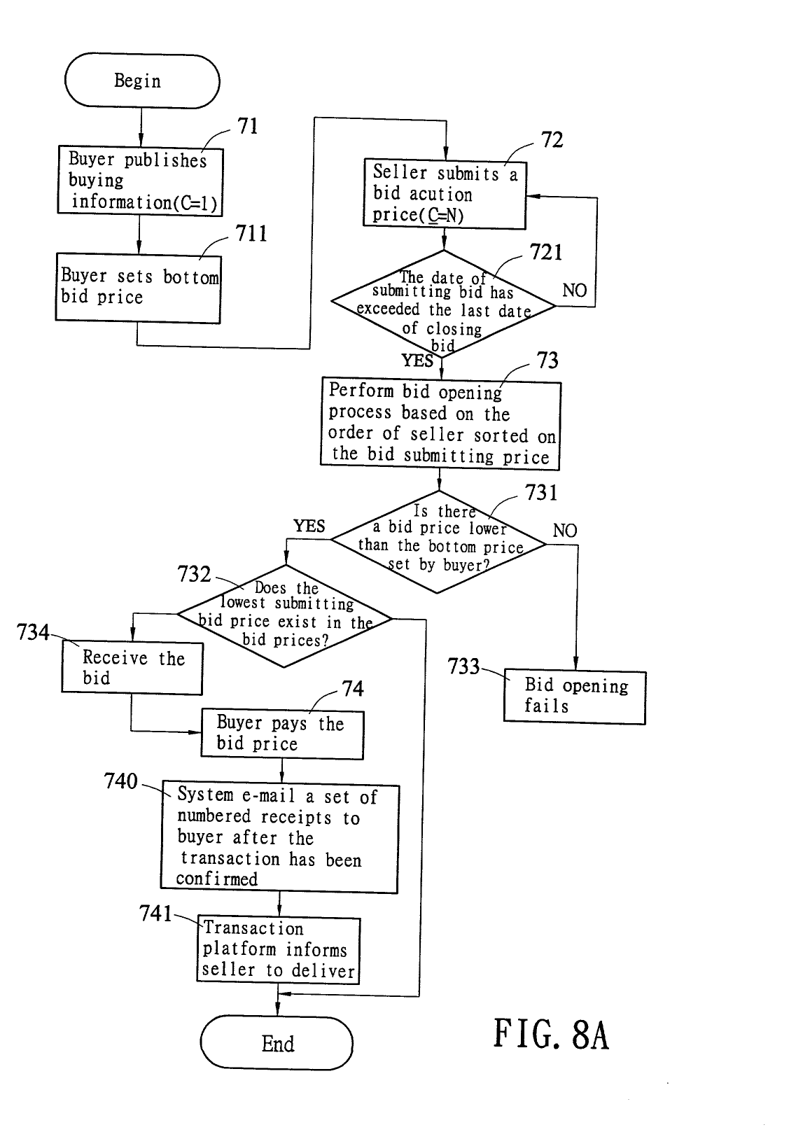

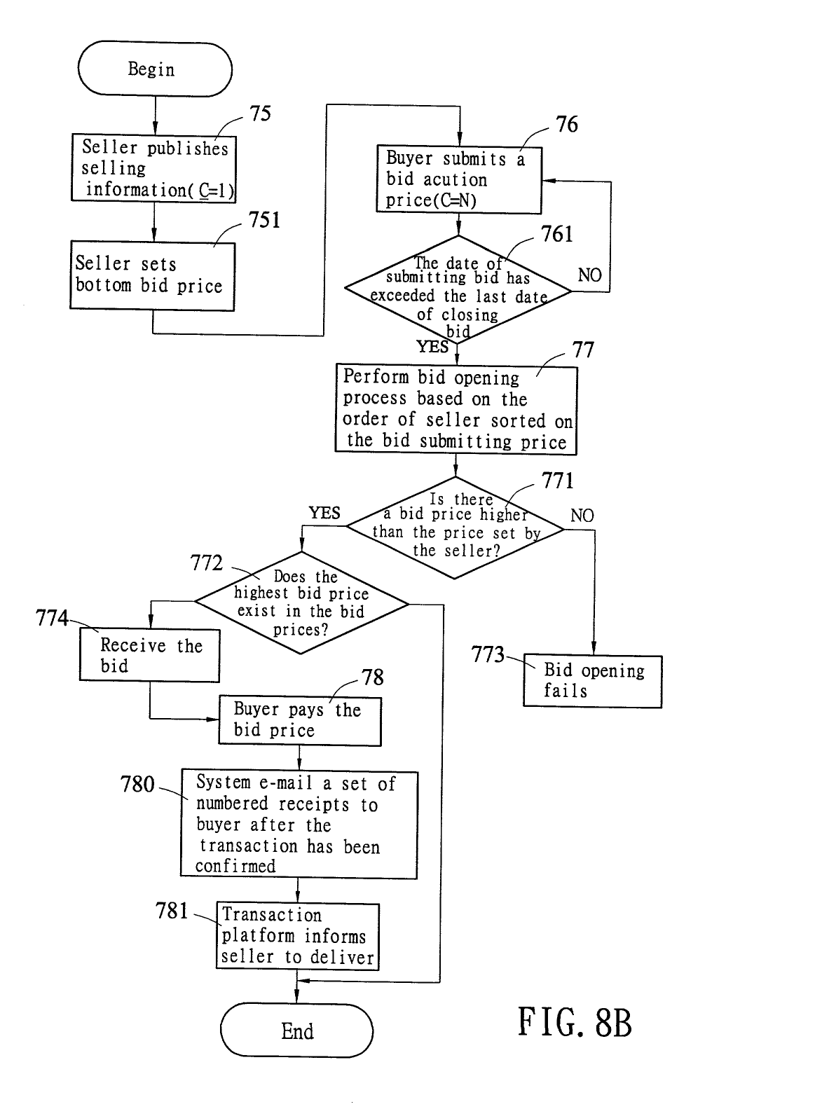

FIG. 8A is a flow chart illustrating a business model involved 1 to N, buyer marketplace, and used product in C2C of the invention. The process comprises the steps of:

In step 71, buyer publishes buying information and C is equal to 1 (C=1). In step 711, set bottom bid price for buyer.

In step 72, submitting bid of auction price for seller and C′=N.

In step 721, it is determined that whether the date of presenting bid has exceeded the last date of closing bid, before the due date of the closing bid, any other sellers may still submit a bid to auction price. If no, process loops back to step 72. If yes, process goes to step 73.

In step 73, perform bid opening process based on the order of each respective sellers sorted on the bid submitting price.

In step 731, it is determined that whether there is a bid price lower than the bottom price set by the seller. If yes, process goes to step 732. If not, the bid opening fails in step 733.

In step 732, it is determined that whether the lowest bid submitting price exists in the bid prices lower than the price set by the seller. If yes, process goes to step 734. If not, process ends.

In step 734, the buyer is decided to receive the bid.

In step 74, buyer pays the bid price.

In step 740, the system e-mail a set of numbered receipts to buyer after the transaction has been confirmed.

In step 741, the transaction platform of the invention informs seller to deliver.

FIG. 8B is a flow chart illustrating a business model involved 1 to N, seller marketplace, and used product in C2C of the invention. The process comprises the steps of:

In step 75, seller publishes seller's selling information and C′ is equal to 1 (C′=1). In step 751, set bottom bid price of seller.

In step 76, submit bid of auction price for buyer and C=N.

In step 761, it is determined that whether the date of presenting bid has exceeded the last date of registration, before the due date of the registration, any other buyers may still submit a bid of auction price. If no, process loops back to step 76. If yes, process goes to step 77.

In step 77, perform bid opening process based on the order of each respective buyers sorted on the bid price.

In step 771, it is determined that whether there is a bid price higher than the price set by the buyer. If yes, process goes to step 772. If not, the bid opening fails in step 773.

In step 772, it is determined that whether the highest bid price exists in the bid prices higher than the price set by the buyer. If yes, process goes to step 774. If not, process ends.

In step 774, the buyer is decided to receive the bid.

In step 78, buyer pays the bid price.

In step 780, the system e-mail a set of numbered receipts to buyer after the transaction has been confirmed.

In step 781, the transaction platform of the invention informs seller to deliver.

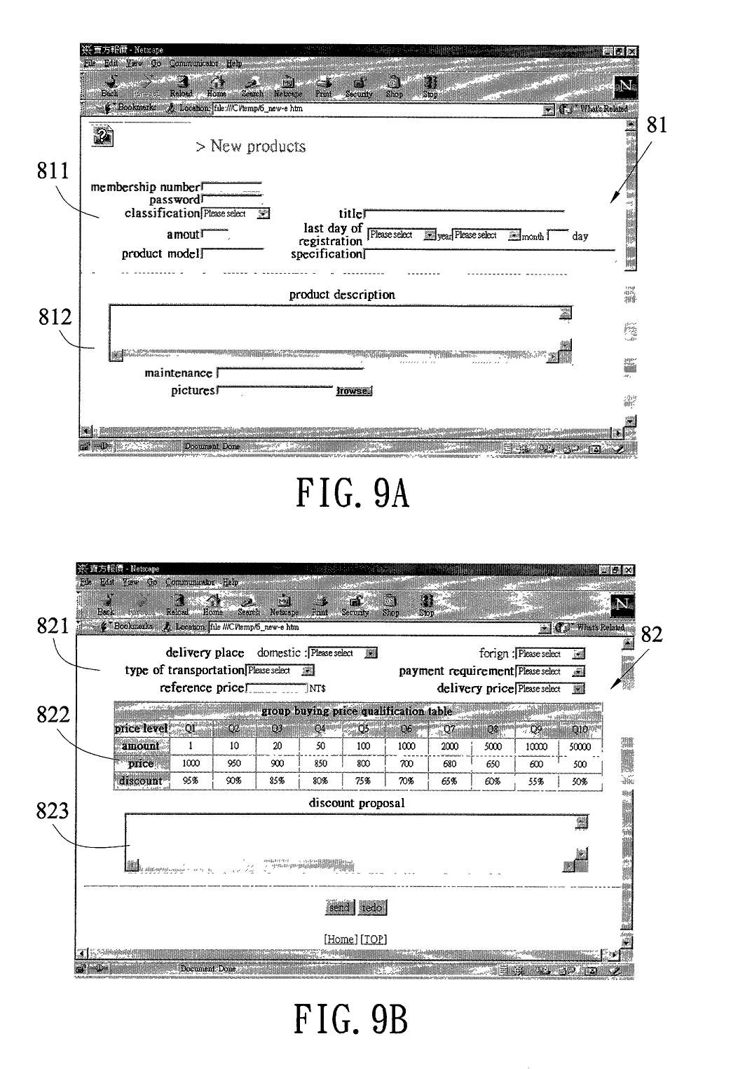

FIGS. 9A and 9B are views showing preferred embodiment homepages of invitation to bid for seller selling of the invention respectively. Front homepage 81 is comprised of a seller basic data region 811 and a product description region 812 wherein seller basic data region 811 comprises membership number, password, classification, title, amount, last day of registration, model, and specifications and product description region 812 comprises product description, maintenance, and pictures. Rear homepage 82 is comprised of a transaction data region 821, a group buying price qualification table 822, and a discount proposal region 823 wherein transaction data region 821 comprises delivery place, transportation, payment requirements, reference price, and delivery price, group buying price qualification table 822 comprises price level field, amount field, price field, and discount field in which the value of price field is decreased as the value of amount field increases, and discount proposal region 823 details information about discount. Browse, send, and redo buttons mechanism are also available on the homepage.

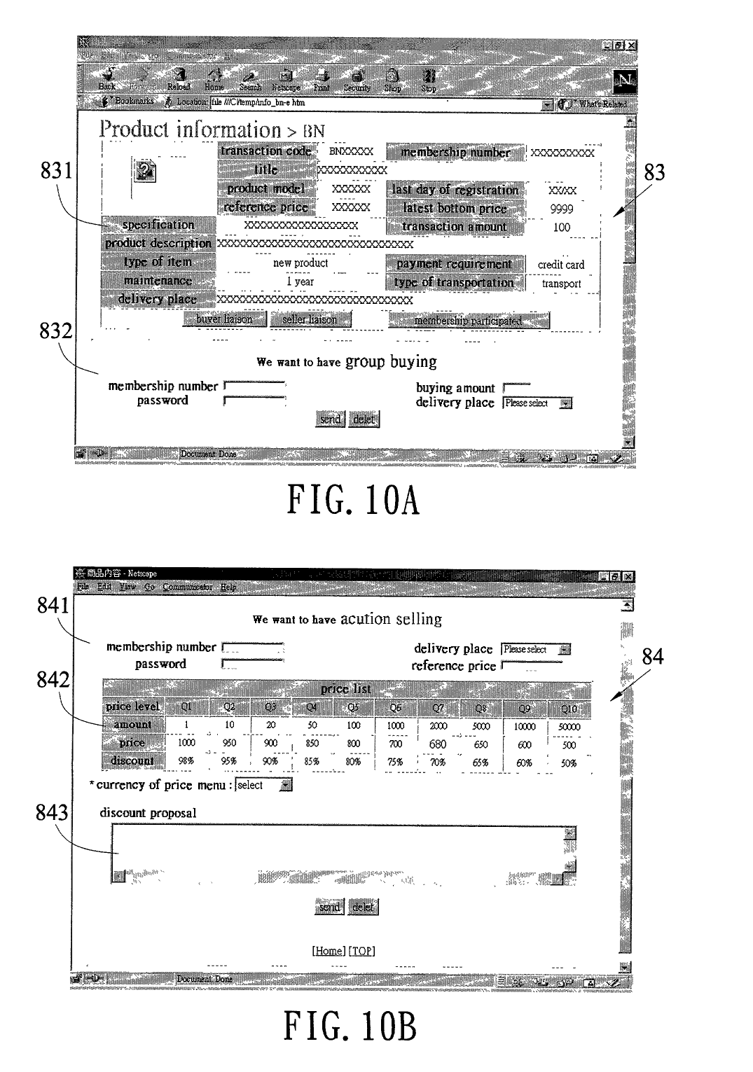

FIGS. 10A and 10B are views showing preferred embodiment homepages of invitation to bid for buyer group buying of the invention respectively. Front homepage 83 is comprised of a buyer's product information region 831 and a group buying registration region 832 wherein buyer's product information region 831 comprises transaction code, membership number, title, model, last day of registration, reference price, latest bottom price, specifications, transaction amount, product description, types of item, payment requirements, maintenance, transportation, and delivery place. The button mechanism for buyer liaison, seller liaison, and membership participated are also available on the homepage. Group buying registration region 832 comprises membership number, buying amount, password, and delivery place. The button mechanism for sending and cancellation are also available on the homepage. Rear homepage 84 is comprised of a selling registration region 841, a price list 842, and discount proposal region 843. Selling registration region 841 comprises membership number, delivery place, password, and reference price. Price list 842 comprises price level field, amount field, price field, and discount field. Currency of price menu is also available. The value of price field is decreased as the value of amount field increases. Discount proposal region 843 details information about discount. The button mechanism for sending and cancellation are also available on the homepage.

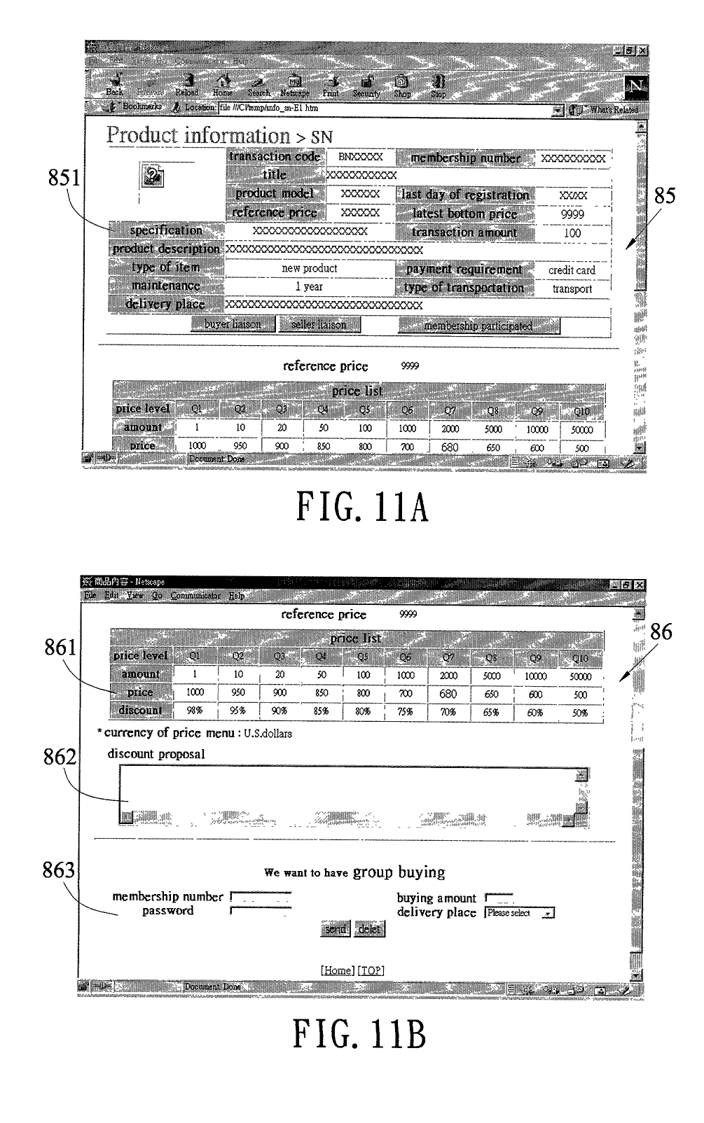

FIGS. 11A and 11B are views showing preferred embodiment homepages of seller bid price of the invention respectively. The homepages comprise a front homepage 85 and a rear homepage 86 wherein the front homepage 85 is comprised of a seller basic data region 851 which is comprised of a transaction code, a membership number, a title, a model, a last day of registration, a reference price, a latest price, a specification, a transaction amount, a product description, types of item, a payment requirements, a maintenance, a transportation, and a delivery place. The button mechanism functioning for buyer liaison, seller liaison, and membership qualification are also available on the homepage. Rear homepage 86 is comprised of a price list 861, discount proposal region 862, and a group buying registration region 863. Price list 861 comprises a price level field, an amount field, a price field, and a discount field. Currency of price menu is also available. The value of price field is decreased as the value of amount field increases. Discount proposal region 862 details information about discount. Group buying registration region 863 comprises a membership number, a buying amount, a password, and a delivery place. The button mechanism functioning for sending and cancellation are also available on the homepage.

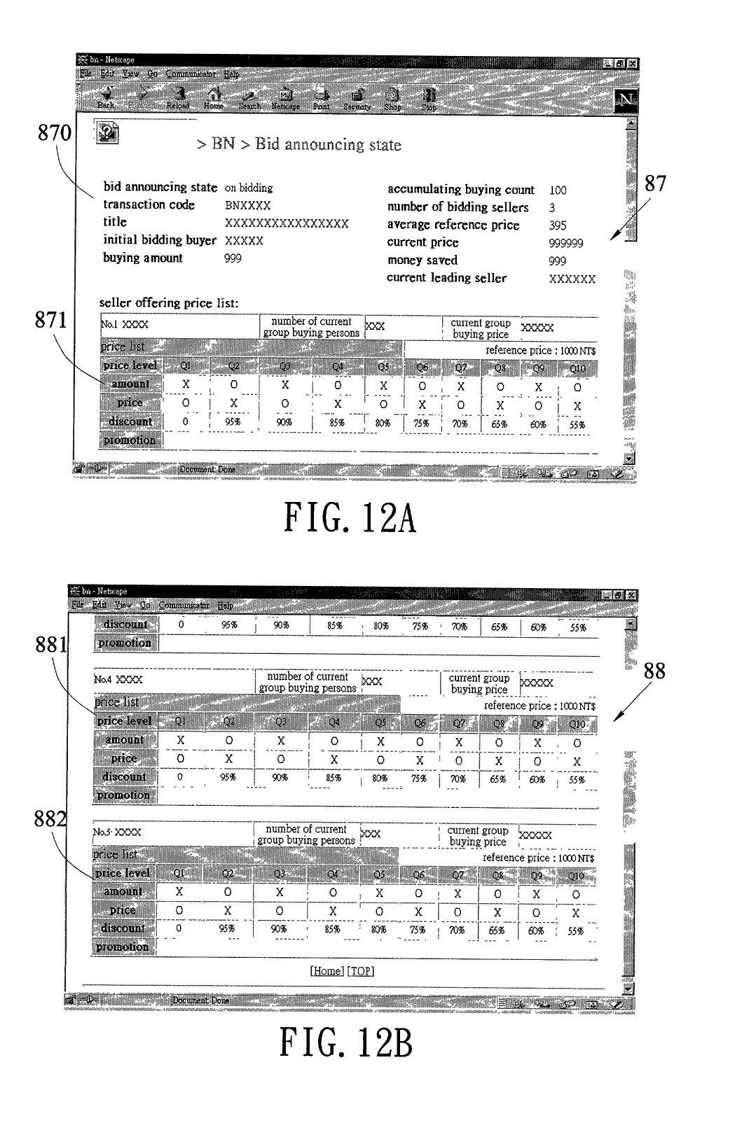

FIGS. 12A and 12B are views showing preferred embodiment homepages of bid announcing state of the invention respectively. The preferred embodiment homepages comprises a front homepage 87 and a rear homepage 88. Front homepage 87 is comprised of a bid announcing state information region 870 and a seller's offering price list 871. Bid announcing state information region 870 comprises the items of bid announcing state, accumulating buying count, transaction code, number of bidding sellers, title, average reference price, initial bidding buyer, current price, buying amount, money saved, and current leading seller. Seller's offering price list 871 comprises a field of number of current group buying persons, a field of current group buying price, price level field, amount field, price field, discount field, and promotion field. The value of price field is decreased as the value of amount field increases. Rear homepage 88 is comprised of a seller's offering price list 881 and a buyer's offering price list 882.

It is to be understood that as mentioned above, the most important spirit of the present invention is to provide a method for integrating e-commerce business model and transaction platform therefor for integrating a plurality of business models of B2B, B2C, C2B, and C2C on the same transaction platform, effecting one to multiple transaction, and effecting multiple to multiple transaction by mean of establishing a buyer's buying marketplace/seller's selling marketplace combining a single or multiple transactional mechanism of an invitation bid/a submitting bid/an auction bid/an announcing bid. By utilizing this, a variety of advantages mentioned above are obtained. For example, buyers and sellers may choose an advantageous functions of business model to deal with a favorable transactions for both the buyer and the seller based on the real market conditions with respect to the demand and the supply situations. Further, a fully competitive marketing economy is effected. Furthermore, a simplified business model and supply chains relationship are obtained. Moreover, a fair, open, high efficiency, and low cost transaction is thus carried out.

While the invention herein disclosed has been described by means of specific embodiments, numerous modifications and variations could be made thereto by those skilled in the art without departing from the scope and spirit of the invention set forth in the claims.

What is claimed is:

1. A method for integrating e-commerce business models comprising the steps of:
(a) classifying a demand invitation published on a homepage as both buyer's buying information and seller's selling information;
(b) integrating a transaction information including classifying the publishing information on the demand invitation as two categories wherein one is buyer marketplace/seller marketplace and the other is new product/used product/services based on a combination of the buyer's buying information and the seller's selling information, and then integrating the same into a database;
(c) establishing a transaction marketplace including establishing a buyer marketplace and a seller marketplace based on the database;
(d) classifying a transaction item as new product, used product, and services based on the database;
(e) establishing a transaction mechanism including creating an invitation to bid for group buying/auction bidding, an invitation to bid for single party/auction bidding, an invitation to bid/group buying auction bidding, and a request for publication services from buyer/seller transaction models based on the transactional marketplace establishment and the classification of transaction item classification;
(f) creating a transaction rule including creating transaction ruler of closing bid, opening bid, and announcing bid based on the transaction mechanism;
(g) defining a number of transaction party as 1 to N or N to N based on the transaction mechanism and transaction rule; and
(h) setting a transaction price based on the transaction rule to announce a reasonable and mutual beneficial price and then come to a transaction price.

2. A transaction platform for integrating e-commerce business models including a business to a business (B2B), a business to a consumer (B2C), a consumer to a business (C2B), and a consumer to a consumer (C2C), the transaction platform comprising:
a new product transaction of buyer marketplace wherein after having published the buying information on a homepage by the buyer, the transaction model is an invitation to bid from buyer group buying for seller auction bidding to attain a price down by increasing a buying volume; the business models are C2B and B2B; the transaction rule is that the bid opening date is set on the date of registration which is the last due date of offering from seller, and the bid announcing for seller is made by buyer's confirmation within three days counting from the bid opening date; the number of transaction party is N to N; the transaction price is set as seller offering price corresponding to an amount of group buying;
a used product transaction of buyer marketplace wherein after having published buying information, the transaction model is an invitation to bid from a single buyer for seller auction bidding, the business models are C2C and B2B; the transaction rule is that the bid announcement date is set on the date of registration which is the last due date of offering from seller and the success of transaction is determined by the system, the number of transaction party is 1 to N, the transaction price is set as the lowest bid price which is required to be lower than the bottom price set in the invitation to bid;
a information transaction of buyer marketplace wherein after having published buyer's buying information, the transaction model is a request for query (RFQ) from buyer; the business models are C2B and C2C; the transaction rule is that making transaction is determined by the seller and buyer themselves before the last due date of buyer's buying information is published, the number of transaction party is N to N, transaction price is agreed by both buyer and seller;
a new product transaction of seller marketplace wherein after having published seller's selling information; the transaction model is an invitation to bid from seller for buyer group buying of auction bidding to obtain price down by increasing buying volume the business models are B2C and B2B the transaction rule is that the system determines the transaction based on the priority of bidding from buyer groups buying after the due date of bid invitation; the number of transaction party is 1 to N. the transaction price is based on the amount of group buying;
a used product transaction of seller marketplace wherein after having published seller's selling information, the transaction model is an invitation to bid from a single seller for buyer auction bidding, the business models are C2C and B2B, the transaction rule is that the bid announcement is set on the date of bid auction which is the last due date of auction bidding from buyer, and the success of transaction is determined by the system, the number of transaction party is 1 to N, the transaction price is set as the highest bid price which is required to be higher than the bottom price set in the invitation to bid;
a information transaction of seller marketplace wherein after having published the seller's selling information, the transaction model is request publication for selling information from seller, the business models are C2C and B2C, the transaction rule is that seller and buyer both decide the transaction before the last due dates of publishing seller's selling information, the number of transaction party is 1 to N, transaction price is agreed by both buyer and seller.

3. A transaction platform for integrating e-commerce business models, the transaction platform comprising the business models of:
(a) C2B: involving model of N to N/buyer marketplace/new product, the functions of business model comprising a C invitation bid mechanism for group buying, a B submitting bid offering mechanism, a bid announcing mechanism for qualification, a C bid announcing registration mechanism, and an online transaction mechanism wherein the C bid announcing registration mechanism is a dynamic bid announcing mechanism with a decided transaction price being based on a volume of a group buying;
(b) B2C: involving model of 1 to N/seller marketplace/new product, the functions of business model comprising a B invitation bid selling mechanism, a C submitting bid group buying mechanism, a B bid announcing mechanism, and an online transaction mechanism wherein the B bid announcing mechanism is a dynamic bid announcing mechanism with a decided transaction price being based on a volume of a group buying;
(c) B2B: involving model of N to N/buyer marketplace/new product, the functions of business model comprising a B invitation bid mechanism for group buying, a B submitting bid offering mechanism, a bid announcing mechanism for qualification, a B bid announcing registration mechanism, and an online transaction mechanism wherein the B bid announcing registration mechanism is a dynamic bid announcing mechanism with a decided transaction price being based on a volume of a group buying;
(d) B2B: involving model of 1 to N/seller marketplace/new product, functions of the business model comprising a B invitation bid mechanism for selling, a B submitting bid mechanism for group buying, a B bid announcing mechanism, and an online transaction mechanism wherein the B bid announcing mechanism is a dynamic bid announcing mechanism with a decided transaction price being based on a-volume of a group buying;
(e) C2C: involving model of 1 to N/buyer marketplace/used product, the functions of business model comprising a C invitation bid procurement mechanism, a C submitting bid auction mechanism, a C bid announcing mechanism, and an online transaction mechanism; and
(f) C2C: involving model of 1 to N/seller marketplace/used product, the functions of business model comprising a C invitation bid selling mechanism, a C submitting bid auction mechanism, a C bid announcing mechanism, and an online transaction mechanism.

4. The transaction platform of claim 3, wherein the business model of C2C involving 1 to N/buyer marketplace/used product is applicable to B2B with respect to used product transaction therebetween.

5. The transaction platform of claim 3, wherein the business model of C2C involving 1 to N/seller marketplace/used product is applicable to B2B with respect to used product transaction therebetween.

6. A transaction platform for integrating e-commerce business models, the transaction platform comprising a homepage of invitation bid for a seller's selling, a homepage of invitation bid for a buyer's group buying, a homepage of seller submitting bid with seller's offer, and a homepage of bid announcing state.

7. The transaction platform of claim 6, wherein the homepage of invitation bid for seller's selling comprises a seller basic data region, a product description region, a transaction data region, a group buying price qualification table, and a discount proposal region.

8. The transaction platform of claim 7, wherein the group buying price qualification table comprises a price level field, an amount field, a price field, and a discount field with a value of the price field decreased as the value of the amount field increased.

9. The transaction platform of claim 6, wherein the homepage of invitation bid for the buyer's group buying comprises a buyer basic data region, a group buying registration region, a selling registration region, a price list, and a discount proposal region.

10. The transaction platform of claim 9, wherein the price list comprises a price level field, an amount field, a price field, and a discount field with a value of the price field decreased as a value of the amount field increased.

11. The transaction platform of claim 6, wherein the homepage of seller bid offering comprises a seller basic data region, a price list, a discount proposal region, and a group buying registration region.

12. The transaction platform of claim 11, wherein the price list comprises a price level field, an amount field, a price field, and a discount field with a value of the price field decreased as a value of the amount field increased.

13. The transaction platform of claim 6, wherein the homepage of bid announcing state comprises a bid announcing state information region and a seller price list.

14. The transaction platform of claim 13, wherein the bid announcing state information region comprises items of a bid announcing state, a buying count, a transaction code, a number of bidding sellers, a title, an average reference price, an initial bidding buyer, a current price, a buying amount, a money saved, and a current leading seller.

15. The transaction platform of claim 13, wherein the seller price list comprises a number of current group buying persons field, a current group buying price field, a price level field, an amount field, a price field, an discount field, and a promotion field with a value of the price field decreased as a value of the amount field increased.
